(19) United States
(12) Patent Application Publication
(10) Pub. No.: US 2009/0311488 A1
(43) Pub. Date: Dec. 17, 2009

(54) DECORATIVE ORNAMENTS AND METHODS FOR MAKING DECORATIVE ORNAMENTS

(76) Inventor: Barbara P. Billauer, Washington, DC (US)

Correspondence Address: PATTON BOGGS LLP, 8484 WESTPARK DRIVE, SUITE 900, MCLEAN, VA, 22102, US

(21) Appl. No.: 12/483,862

(22) Filed: Jun. 12, 2009

Related U.S. Application Data
(60) Provisional application No. 61/129,233, filed on Jun. 12, 2008.

(51) Int. Cl. B32B 3/10; B05D 1/36; B05D 5/00; B32B 1/00

(52) U.S. Cl. 428/187; 427/402; 427/262; 427/261; 428/174

(57) ABSTRACT

The present invention relates to the field of decorative arts and crafts and to the field of jewelry making. The present invention provides a method for making a decorative ornament comprising the steps of providing a transparent, semi-transparent, translucent, or semi-opaque substrate; and applying a colorant to the substrate, wherein the colorant also acts as a sealant. The present invention provides a method for making a decorative ornament comprising the steps of providing a transparent, semi-transparent, translucent, or semi-opaque substrate; and applying a colorant to the substrate, wherein the colorant also acts as a sealant and an additional sealant is applied. The present invention also provides a method for making a decorative ornament comprising the steps of providing a transparent, semi-transparent, translucent, or semi-opaque substrate; applying a first colorant to the substrate; and applying sealant to seal the colorant. The inventive decorative ornaments may be mounted in jewelry settings or be affixed to items such as jewelry, accessories, clothing, household items, furniture, and office items. The decorative ornaments of the present invention have a rich, deep, jewel-like luster. The appearance of decorative ornaments according to the present invention is not of a flat colorant on the bottom of the substrate. Rather, the entire decorative ornament preferably appears to be suffused with color and has a shiny, jewel-like appearance.

### CROSS-REFERENCE TO RELATED APPLICATIONS

This application claims the benefit of U.S. Provisional Application Ser. No. 61/129,233 filed Jun. 12, 2008, which is incorporated by reference herein in its entirety.

### FIELD OF THE INVENTION

The present invention relates to the field of decorative arts and crafts and to the field of jewelry making. The present invention relates to decorative ornaments comprising a substrate, a colorant, and, optionally, a sealant. The inventive decorative ornaments have an unexpected rich, deep, jewel-like luster. The inventive decorative ornaments may be mounted in jewelry settings or be affixed to items such as jewelry, accessories, clothing, household items, furniture, and office items.

### BACKGROUND OF THE INVENTION

Use of semi-precious or precious stones to decorate items such as accessories, clothing, household items, furniture, and office items, is prohibitively expensive. Semi-precious or precious stones are extremely expensive for use in jewelry. Currently-available decorative elements, such as solid colored glass and plastic decorative elements, that can be used to make costume jewelry and to decorate items such as accessories, clothing, household items, furniture, and office items, lack depth and shine and are devoid ofjewel-like appearance.

Additionally, although methods of coloring glass, plastic, acrylic, and the like are known in the art, they have many disadvantages. For example, such methods typically use toxic materials, high heat, or expensive equipment; are difficult and necessarily time consuming; can only be performed by a highly-trained artisan; and result in a flat appearing object—despite all of the difficulties of the methods, the resultant object lacks depth and shine and is devoid of jewel-like appearance.

Accordingly, there is need for attractive decorative ornaments having a deep, shiny, jewel-like appearance. There is need for a method for producing attractive decorative ornaments having a deep, shiny, jewel-like appearance that can be performed using inexpensive, relatively safe materials. There is need for a method for producing attractive decorative ornaments having a deep, shiny, jewel-like appearance that can be performed without significant training.

### SUMMARY OF THE INVENTION

In one embodiment, the present invention provides a method for making a decorative ornament comprising the steps of providing a transparent, semi-transparent, translucent, or semi-opaque solid substrate and applying a colorant to the substrate, wherein the colorant also acts as a sealant. The substrate comprises at least one relatively flat surface or concave surface and at least one convex or domed surface, and the colorant is applied to at least the flat or concave surface.

In another embodiment, the present invention provides a method for making a decorative ornament comprising the steps of providing a transparent, semi-transparent, translucent, or semi-opaque solid substrate; applying a first colorant to the substrate; and applying sealant to the colorant. The substrate has at least one relatively flat or concave surface and at least one convex or domed surface, and the colorant and sealant are applied to at least the flat or concave surface.

In some embodiments, the method of the present invention comprises the additional step of applying a second colorant. In certain embodiments, the first colorant is translucent and the second colorant is opaque. In certain embodiments, the second colorant is applied in a pattern, such as a pattern resembling veining or inclusions in natural stone or a geometric pattern. In certain embodiments, the second colorant is applied in a shape, such as the shape of a letter or letters. In certain embodiments, additional colorant(s) are applied. In certain embodiments, the additional colorant(s) are applied in a pattern, such as a pattern resembling veining or inclusions in natural stone or a geometric pattern. In certain embodiments, the additional colorant(s) are applied in a shape, such as the shape of a letter or letters.

In one embodiment, the present invention provides decorative ornaments comprising a transparent, semi-transparent, translucent, or semi-opaque solid substrate having at least one raised convex or domed surface and at least one relatively flat or concave surface; and at least one colorant applied to at least one relatively flat or concave surface of the substrate, wherein the at least one colorant also acts as a sealant.

In one embodiment, the present invention provides decorative ornaments comprising a transparent, semi-transparent, translucent, or semi-opaque solid substrate having at least one raised convex or domed surface and at least one relatively flat or concave surface; at least one colorant applied to at least one relatively flat or concave surface of the substrate; and at least one sealant sealing the colorant.

In some embodiments, the present invention provides decorative ornaments comprising a second colorant applied to at least the same relatively flat or concave surface of the substrate to which the first colorant is applied. In some embodiments, the first colorant is translucent and the second colorant is opaque. In certain embodiments, the second colorant is applied in a pattern, such as a pattern resembling veining or inclusions in natural stone or a geometric pattern. In certain embodiments, the second colorant is applied in a shape, such as the shape of a letter or letters. In some embodiments, decorative ornaments of the present invention comprise additional colorant(s) applied to at least the same relatively flat or concave surface of the substrate to which the first colorant, second colorant, or both are applied. In certain embodiments, additional colorant(s) are applied in a pattern, such as a pattern resembling veining or inclusions in natural stone or a geometric pattern. In certain embodiments, additional colorant(s) are applied in a shape, such as the shape of a letter or letters.

### BRIEF DESCRIPTION OF THE DRAWINGS

FIGS. 1A-1D show elevational views of exemplary substrates suitable for use in the present invention.

FIG. 2 shows an elevational view of another exemplary substrate suitable for use in the present invention.

FIGS. 3A-3B show elevational views of other exemplary substrates suitable for use in the present invention.

### DETAILED DESCRIPTION OF THE PREFERRED EMBODIMENTS

Any definitions provided are for reason of clarity and should not be considered as limiting. Except where noted, the terms used herein are intended to have the same meaning as commonly understood by one of ordinary skill in the fields to which the invention pertains.

A decorative ornament according to the present invention is produced by applying at least one colorant to a substrate. In certain embodiments, at least one colorant also acts a sealant, and no additional sealant is applied. In certain embodiments, at least one colorant acts as a sealant, and at least one additional sealant is applied over at least one colorant. In certain embodiments, at least one colorant does not act as a sealant, and at least one sealant is applied over at least one colorant. In certain embodiments, at least one sealant is applied over some portions or areas of colorant, but not other portions or areas. In certain embodiments, at least one sealant is applied directly to the substrate in some portions or areas.

Decorative ornaments according to the present invention are produced using transparent, semi-transparent, translucent, or semi-opaque substrates. Transparent, semi-transparent, and translucent substrates are preferred. The substrates may be colored, pearlescent, opalescent, or clear. The substrates are preferably solid bodied. Hollow substrates may be used. Suitable materials for substrates include glass, plastics, resins, acrylics, simulated gemstones, and crystal.

The size of the substrate is not critical. Preferred substrates are of an appropriate size to be mounted in jewelry settings or to be affixed to items such as jewelry, accessories, clothing, household items, furniture, and office items.

In preferred embodiments, substrates comprise a relatively flat surface and a raised convex or domed surface. By “relatively flat,” it is meant that the surface is generally flat, but need not be perfectly flat or level. When a substrate comprising a relatively flat surface and a raised convex or domed surface is used, colorant, sealant, or both are applied to at least the relatively flat surface. In preferred embodiments, colorant is applied to most of the relatively flat surface. By “most,” it is meant that about 51% or more; preferably about 55%, 60%, 65%, 70%, 75% 80%, 85%, 90%, 95%, or more, most preferably about 99% to 100% of the relatively flat surface has colorant applied thereto. Colorant applied to “most” of a surface may be relatively uniform. Colorant applied to “most” of a surface may comprise, for example, patterns, shapes, or both. Colorant applied to “most” of a surface may comprise one or more different colors, one or more different colorants, and one or more different densities of colorant. In other embodiments, less than 51% of the relatively flat surface has colorant applied thereto. Colorant applied to less than 51% of a surface may be relatively uniform. Colorant applied to less than 51% of a surface may comprise, for example, patterns, shapes, or both. Colorant applied to less than 51% of a surface may comprise one or more different colors, one or more different colorants, and one or more different densities of colorant. Areas without colorant may be, for example, in a pattern or shape or may be random. Colorant, sealant, or both may also be applied to the raised convex or domed surface.

In other embodiments, substrates comprise a concave surface and a raised convex or domed surface. When a substrate comprising a concave surface and a raised convex or domed surface is used, colorant, sealant, or both is preferably applied to at least the concave surface. In preferred embodiments, colorant is applied to most of the concave surface. In other embodiments, less than 51% of the concave surface has colorant applied thereto. Areas without colorant may be in a pattern or shape or may be random. Colorant, sealant, or both may also be applied to the raised convex or domed surface.

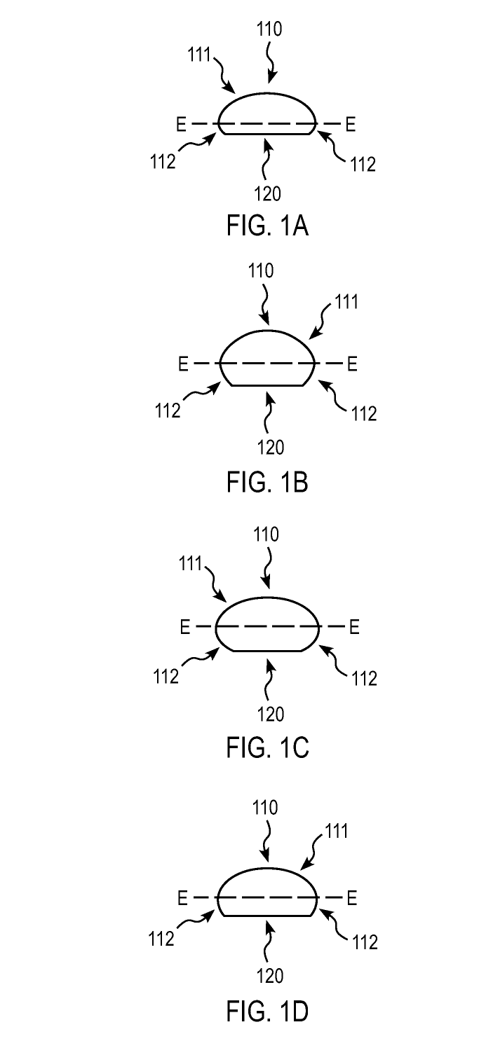

Exemplary suitable substrates comprising a relatively flat surface and a raised convex or domed surface are illustrated in FIGS. 1A-D. The exemplary substrates of FIGS. 1A-1D each have a relatively flat surface 120, which may be referred to as a “bottom” or “bottom surface.” The exemplary substrates of FIGS. 1A-1D each have a raised convex or domed surface 110, which may be referred to as a “dome” or “dome surface.” Surface 110 of each of the exemplary substrates of FIGS. 1A-1D comprises a change of curvature. The line around the circumference of surface 110 at which the curvature changes is indicated by dashed line E in FIGS. 1A-1D. It is to be understood that line E need not actually appear as a line on surface 110. Surface 112 is the portion of surface 110 below line E (i.e., closer to bottom surface 120). Surface 112 may be referred to as a “shoulder,” “shoulder surface,” or “shoulder portion” of dome surface 110. Surface 111 is the portion of surface 110 above line E (i.e., farther from bottom surface 120). Surface 111 may be referred to as a “top,” “top surface,” or “top portion” of dome surface 110. Together, top surface 111 and shoulder surface 112 comprise dome surface 110 of the exemplary substrates of FIGS. 1A-1D. Where a substrate such as the exemplary substrates of FIGS. 1A-1D is used, colorant, sealant, or both are applied to at least a portion of bottom surface 120. In preferred embodiments, colorant is applied to most of bottom surface 120. In other embodiments, less than 51% of bottom surface 120 has colorant applied thereto. Areas without colorant may be, for example, in a pattern or shape or may be random. Colorant, sealant, or both also may be applied to dome surface 110. Colorant, sealant, or both may, for example, be applied only to shoulder surface 112, only to top surface 111, or to all of dome surface 110. In certain embodiments, colorant is applied to most of shoulder surface 112, top surface 111, or both. In other embodiments, colorant is applied to less than 51% of top surface 111, shoulder surface 112, or both. In still other embodiments, no colorant is applied to shoulder surface 112, top surface 111, or both.

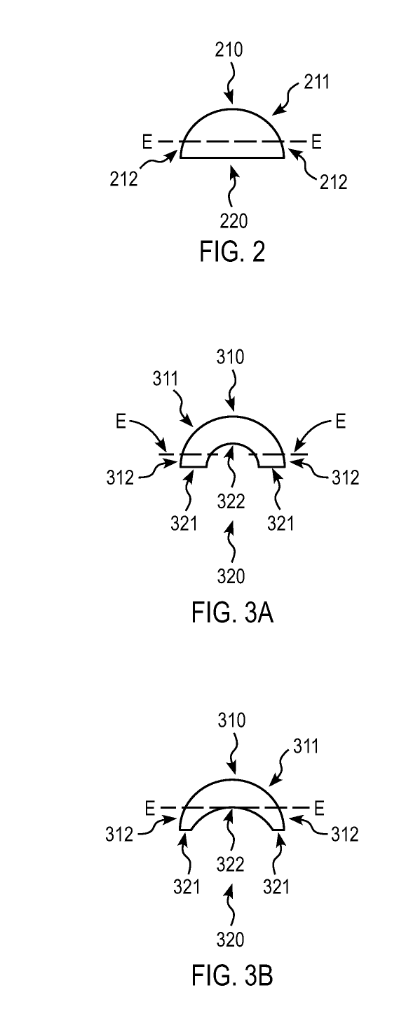

Another exemplary suitable substrate comprising a relatively flat surface and a raised convex or domed surface is illustrated in FIG. 2. The exemplary substrate of FIG. 2 has a relatively flat surface 220, which may be referred to as a “bottom” or “bottom surface,” and a raised convex or domed surface 210, which may be referred to as a “dome” or “dome surface.” Where a substrate such as the exemplary substrate of FIG. 2 is used, colorant, sealant, or both are applied to at least a portion of bottom surface 220. In preferred embodiments, colorant is applied to most of bottom surface 220. In other embodiments, colorant is applied to less than 51% of bottom surface 220. Areas without colorant may be, for example, in a pattern or shape or may be random. Colorant, sealant, or both also may be applied to dome surface 210. In certain embodiments, colorant is applied to a portion of dome surface 210 that is closer to bottom surface 220, and the portion of dome surface 210 that is farther from bottom surface 220 is left without colorant or has a different colorant applied thereto. For ease of reference, FIG. 2 has a dashed line E around the circumference of surface 210. Line E is not located at any particular predetermined location, but is chosen by the practitioner to achieve desired effects. It is to be understood that line E need not actually appear as a line on surface 210. For ease of reference, the portion of surface 210 below line E (i.e., closer to bottom surface 220) will be referred to as surface 212. Surface 212 may be referred to as a “shoulder,” “shoulder surface,” or “shoulder portion” of dome surface 210. Also for ease of reference, the portion of surface 210 above line E (i.e., farther from bottom surface 220) will be referred to as surface 211. Surface 211 may be referred to as a “top,” “top surface,” or “top portion” of dome surface 210. Together, top surface 211 and shoulder surface 212 comprise dome surface 210 of the exemplary substrate of FIG. 2. Colorant, sealant, or both may, for example, be applied to only to shoulder surface 212, only to top surface 211, or to all of dome surface 210. In certain embodiments, colorant is applied to most of shoulder surface 212, top surface 211, or both. In other embodiments, colorant is applied to less than 51% of top surface 211, shoulder surface 212, or both. In still other embodiments, no colorant is applied to shoulder surface 212, top surface 211, or both.

Exemplary suitable substrates comprising a concave surface and a raised convex or domed surface are illustrated in FIGS. 3A-3B. The exemplary substrates of FIGS. 3A-3B have a relatively flat donut- or torus-shaped surface 321, which may be referred to as a “foot” or “foot surface”; a concave surface 322; and a raised convex or domed surface 310, which may be referred to as a “dome” or “dome surface”. Foot surface 321 and concave surface 322 may be referred to collectively as the “bottom” or “bottom surface” of the exemplary substrates of FIGS. 3A-3B. When a substrate comprising a concave surface and a raised convex or domed surface such as the exemplary substrates of FIGS. 3A-3B is used, colorant, sealant, or both are applied to at least a portion of at least one of concave surface 322 or foot surface 321. In preferred embodiments, colorant is applied to most of at least one of concave surface 322 or foot surface 321. In other embodiments, colorant is applied to less than 51% of concave surface 322, foot surface 321, or both. Areas without colorant may be, for example, in a pattern or shape or may be random. Colorant, sealant, or both also may be applied to dome surface 310. In certain embodiments, colorant is applied to a portion of dome surface 310 that is closer to bottom surface 320, and the portion of dome surface 310 that is farther from bottom surface 320 is left without colorant or has a different colorant applied thereto. For ease of reference, FIGS. 3A-3B have a dashed line E around the circumference of surface 310. Line E is not located at any particular predetermined location, but is chosen by the practitioner to achieve desired effects. It is to be understood that line E need not actually appear as a line on surface 310. For ease of reference, the portion of surface 310 below line E (i.e., closer to bottom surface 320) will be referred to as surface 312. Surface 312 may be referred to as a “shoulder,” “shoulder surface,” or “shoulder portion” of dome surface 310. Also for ease of reference, the portion of surface 310 above line E (i.e., farther from bottom surface 320) will be referred to as surface 311. Surface 311 may be referred to as a “top,” “top surface,” or “top portion” of dome surface 310. Together, top surface 311 and shoulder surface 312 comprise dome surface 310 of the exemplary substrates of FIGS. 3A-3B. Colorant, sealant, or both may, for example, be applied to only to shoulder surface 312, only to top surface 311, or to all of dome surface 310. In certain embodiments, colorant is applied to most of shoulder surface 312, top surface 311, or both. In other embodiments, colorant is applied to less than 51% of shoulder surface 312, top surface 311, or both. In still other embodiments, no colorant is applied to shoulder surface 312, top surface 311, or both.

A preferred substrate comprises a relatively flat, relatively round, or relatively oval bottom surface and a raised convex or domed surface. By “relatively round,” it is meant that the surface is generally round, but need not be perfectly round or circular, and may have imperfections or deviate towards an oval shape. By “relatively oval,” it is meant that the surface is generally oval, but need not be perfectly oval, and may have imperfections or deviate towards an ovoid or egg shape. In substrates such as those illustrated in FIGS. 1A-1D and 2, the bottom surface is a solid circle or oval. In substrates such as that illustrated in FIGS. 3A-3B, the bottom comprises two surfaces: a donut- or torus-shaped foot surface and a concave surface. In a particularly preferred embodiment, the substrate comprises a relatively flat, relatively round surface of 13 mm to 19 mm in diameter, and a raised convex or domed surface of 7 mm to 9 mm in height.

Decorative ornaments according to the present invention are produced by applying at least one colorant to a substrate. Where a substrate such as the exemplary substrates of FIGS. 1A-1D is used, at least one colorant is applied to at least a portion of bottom surface 120. One or more colorant also may be applied to dome surface 110. One or more colorant may, for example, be applied to only to shoulder surface 112, only to top surface 111, or to both. Where a substrate such as the exemplary substrate of FIG. 2 is used, at least one colorant is applied to at least a portion of bottom surface 220. One or more colorant also may be applied to dome surface 210. One or more colorant may, for example, be applied to only to shoulder surface 212, only to top surface 211, or to both. When a substrate comprising a concave surface and a raised convex or domed surface is used, at least one colorant is applied to at least a portion of at least one of concave surface 322 or foot surface 321. One or more colorant may be applied to both concave surface 322 and foot surface 321. One or more colorant also may be applied to dome surface 310. One or more colorant may, for example, be applied to only to shoulder surface 312, only to top surface 311, or to both.

Colorant(s) applied to the bottom surface of the substrate is viewed through the convex or domed surface of the substrate. Where colorant(s) is applied to the shoulder surface and bottom surface of a substrate, the colorant(s) is viewed through the top portion of the convex or domed surface of the substrate. The result is that the decorative ornament has a rich, deep, jewel-like luster. The appearance of decorative ornaments according to the present invention is, unexpectedly, not that of a flat layer of color on the bottom, shoulder, or both of the substrate, as would be created by, for example, painting on one side of a flat piece of glass and viewing the painted surface through the other side of the glass. Rather, in decorative ornaments according to the invention, the entire decorative ornament appears to be suffused with color when viewed from the top or at an angle. While not wishing to be limited to a particular scientific theory or explanation, it is believed that the unique optical properties and jewel-like appearance of the inventive decorative ornaments are created by the reflection and refraction of light by and within the convex or domed shape of the substrate.

Depending on the colorant, or combination of colorants, used and the characteristics of the substrate—e.g., whether the substrate is transparent, semi-transparent, or translucent, colored, pearlescent, opalescent, or clear—the appearance of the decorative ornament can be tailored. For example, decorative ornaments according to the present invention may resemble natural materials such as pearl, mother-of-pearl, abalone, amber, tortoise shell, and precious or semi-precious gemstones, such as opal, ruby, emerald, sapphire, amethysts, hematite, peridot, citrine, and tourmaline. Decorative ornaments according to the present invention need not, however, resemble natural semi-precious or precious stones. Any desired coloration, including patterns and shapes, may be used and will be enhanced by the rich, deep, jewel-like luster of the decorative ornaments of the present invention. Thus, jewel-like decorative ornaments can be created in any color or color combination, including colors that may not be available in natural stones or other natural materials.

Suitable colorants include colored, iridescent, pearlescent, or metallic water-based paints, inks, dyes, and pigments; colored, iridescent, pearlescent, or metallic alcohol-based paints, inks, dyes, and pigments; colored, iridescent, pearlescent, or metallic oil-based paints, inks, dyes, and pigments; colored, iridescent, pearlescent, or metallic acrylic paints; colored, iridescent, pearlescent, or metallic latex paints; wood stains; colored, iridescent, pearlescent, or metallic automobile paints, including touch-up paints; and colored, iridescent, pearlescent, or metallic lacquers, enamels, varnishes, nail polishes, and nail lacquers. These categories may be referred to as “types” of colorants. Suitable colorants include colorants that are opaque, semi-opaque, or translucent upon application or drying. Glitter, glitterant (microcrystals), or other inclusions may be included in colorants.

Colorants that are compatible with each other, meaning that they can be mixed without reacting with or separating from each other, such as two oil-based colorants, may be mixed before being applied to the substrate. Colorants may be diluted with diluents, dispersants, or detergents to achieve a desired consistency or appearance before being applied to the substrate. Diluents, dispersants, or detergents that are compatible with different types of colorants are known in the art.

The opacity of many colorants may be increased by applying two or more layers of the colorant to the substrate. Accordingly, any given colorant may appear more or less opaque, depending on the number of layers applied. It will readily apparent to one of skill in the art that a particular color, such as red, will be available as different types of colorants, albeit not always in the exact same shade or hue. Similarly, many colors are available in each type of colorant.

Colorants may be applied by any method effective to apply the colorant to the substrate. For example, colorant may be brushed, dabbed, or sprayed onto the substrate. Colorant in the form of paint pens, felt tip pens, furniture touch-up pens, automobile touch-up paint pens, and markers, such as magic markers, permanent markers, and quick-drying markers may also be used.

One or more relatively uniform layer(s) of colorant is preferably applied to at least the bottom surface of the substrate. By “relatively uniform layer(s)” it is meant that a layer of one colorant is applied to the substrate without a pattern; perfect uniformity or color density is not required. Colorant(s) may also be applied in a pattern or patterns. By “pattern” it is meant that colorant(s) is applied to the substrate non-uniformly; repetition or uniformity of spacing between portions of the pattern is not required. Patterns may comprise, for example, lines, swirls, dots, spots, patterns resembling veining or inclusions in natural stone, geometric patterns, and otherwise non-uniform applications of colorant. Colorant(s) may also be applied in the form of a shape or shapes, such as, for example, the shape of a letter or letters, heart(s), or star(s). Areas may be left without colorant. Areas without colorant may be, for example, in a pattern or shape or may be random. Relatively uniform layer(s) of colorant(s) may be combined, overlayed, or underlayed with additional relatively uniform layers of the same or one or more other colorants, or with the same or one or more other colorant(s) applied non-uniformly, such as in a pattern or patterns or in a shape or shapes. Since the opacity of many colorants may be increased by applying additional layers of the same colorant, patterns and shapes can be created using a single colorant with areas of different opacities. Patterns and shapes can be created using two or more colorants.

More than one type or color of colorant may be applied to the same surface of the substrate, as non-limiting examples, in a single layer, in successive layers, in a pattern or shape created by applying different colorants next to one another, or in a pattern or shape created by applying different colorants in layers. Successive layers of the same or different colorant may be applied until the desired color, color saturation, and opacity are achieved. A colorant may be allowed to dry before another colorant is applied, such as if mixing of the colorants is desired to be avoided. In contrast, another colorant may be applied before the previous colorant(s) is allowed to dry, such as if mixing of the colorants is desired.

In one preferred embodiment, one or more relatively uniform layer(s) of translucent or semi-opaque colorant(s) is applied to the bottom surface of a substrate; and one or more pattern(s) or shape(s) of one or more opaque or semi-opaque colorant(s) are applied on the layer of translucent colorant(s). In a similar preferred embodiment, one or more relatively uniform layer(s) of translucent or semi-opaque colorant(s) is applied to the bottom and shoulder surfaces of a substrate, and one or more pattern(s) or shape(s) of one or more opaque or semi-opaque colorant(s) are applied on the layer of translucent colorant(s). The pattern or patterns may comprise, for example, lines, swirls, dots, or spots, a pattern resembling veining or inclusions in natural stone, or a geometric pattern. The shape or shapes, may comprise, for example, the shape of a letter or letters, heart(s), or star(s). Areas may be left without colorant. Areas without colorant may be, for example, in a pattern or shape or may be random. The translucent colorant(s) may be, for example, a water-based colorant(s), such as magic marker; and the opaque colorant(s) may be, for example, an oil-based or acrylic colorant(s) or permanent marker. The translucent, semi-opaque, and opaque colorants may be the same or different colors.

In another preferred embodiment, one or more pattern(s) or shape(s) of one or more opaque, semi-opaque, or translucent colorant(s) are applied to the bottom surface of a substrate; then one or more relatively uniform layer(s) of opaque, semi-opaque, or translucent colorant(s) is applied to the bottom surface of the substrate. In a similar preferred embodiment, one or more pattern(s) or shape(s) of one or more opaque, semi-opaque, or translucent colorant(s) are applied to the bottom and shoulder surfaces of a substrate; then one or more relatively uniform layer(s) of opaque, semi-opaque, or translucent colorant(s) is applied to the bottom and shoulder surfaces of the substrate. The pattern or patterns may comprise, for example, lines, swirls, dots, or spots, a pattern resembling veining or inclusions in natural stone, or a geometric pattern. The shape or shapes, may comprise, for example, the shape of a letter or letters, heart(s), or star(s). Areas may be left without colorant. Areas without colorant may be, for example, in a pattern or shape or may be random. The translucent colorant(s) may be, for example, a water-based colorant(s), such as magic marker; and the opaque colorant(s) may be, for example, an oil-based or acrylic colorant or permanent marker. The translucent, semi-opaque, and opaque colorants may be the same or different colors.

The present inventor has discovered that the saturation of color of the decorative ornaments can be increased and intensified by applying colorant to part(s) or most of the dome surface of a substrate, in addition to the bottom surface. Thus, in another preferred embodiment, one or more relatively uniform layer(s) of opaque, semi-opaque, or translucent colorant is applied to the bottom surface of a substrate; and one or more relatively uniform layer(s) of translucent colorant(s) is applied to the part(s) or most of dome surface of the substrate. In a similar preferred embodiment, one or more relatively uniform layer(s) of opaque, semi-opaque, or translucent colorant is applied to the bottom and part(s) or most of shoulder surfaces of a substrate; and one or more relatively uniform layer(s) of translucent colorant(s) is applied to the part(s) or most of top surface of the substrate. Similar embodiments will be apparent to the skilled artisan who is given the teachings of the present invention, and such embodiments are within the scope of this invention. For example, any combination of the following may be used: (A) one or more relatively uniform layer(s) of opaque, semi-opaque, or translucent colorant is applied to parts or most of the bottom surface; (B) one or more relatively uniform layer(s) of opaque, semi-opaque, or translucent colorant is applied to parts or most of the shoulder surface; (C) one or more relatively uniform layer(s) of translucent colorant is applied to parts or most of the top surface of the dome; and (D) one or more relatively uniform layer(s) of translucent colorant is applied to parts or most of the entire dome surface. In such embodiments, the colorant(s) applied to the bottom, shoulder, or both may be the same or different colorant or color as the colorant(s) applied to the shoulder, the top, or both. One or more different colorant(s) or colors may be applied to each of the shoulder, the top, and the bottom. In embodiments such as these, one or more pattern(s) or shape(s) of opaque, semi-opaque, or translucent colorant(s) may be applied to the bottom surface, shoulder surface, or both of a substrate before or after the one or more relatively uniform layer(s) of opaque, semi-opaque, or translucent colorant is applied thereto. The pattern or patterns may comprise, for example, lines, swirls, dots, or spots, a pattern resembling veining or inclusions in natural stone, a geometric pattern, or otherwise non-uniformly. The shape or shapes, may comprise, for example, the shape of a letter or letters, heart(s), or star(s). Areas may be left without colorant. Areas without colorant may be, for example, in a pattern or shape or may be random. The translucent colorant(s) may be, for example, a water-based colorant(s), such as magic marker; and the opaque colorant(s) may be, for example, an oil-based or acrylic colorant or permanent marker. The translucent, semi-opaque, and opaque colorants may be the same or different colors.

In certain embodiments, such as where lacquer, enamel, nail polish, or nail lacquer is used as colorant, the colorant will also act as a sealant. In such embodiments, an additional sealant may optionally be applied to seal the colorant.

In embodiments where paint, ink, dye, pigment, or stain is used as colorant, it is preferable to seal the colorant using at least one sealant. Suitable sealants include lacquer, varnish, nail polish, nail lacquer, and nail polish sealant. Preferable sealants are clear. Preferable sealants do not take on a yellow tinge after drying. Sealants may be applied by any method effective to apply the sealant to the substrate. For example, sealant may be brushed, dabbed, or sprayed onto the colorant. The entire substrate, or the surface(s) of the substrate on which colorant is applied, may be dipped into sealant. Colorant may be allowed to dry before sealant is applied, or sealant may be applied before the colorant is dry. In some embodiments, at least one sealant is applied over some portions or areas of colorant, but not others. In some embodiments, at least one sealant is applied directly to some portions or areas of the substrate.

Additional elements such as glitter, glitterant, foil shapes, paper shapes, and fabric shapes may be adhered to the substrate at any stage. For example, such elements may be adhered to the substrate before colorant is applied, may be adhered to the colorant before sealant is applied, may be adhered within the sealant by applying them before the sealant has dried, or may be adhered to the sealant after it has dried. Elements may be adhered to the substrate, colorant, or dried sealant using adhesives such as those described herein.

In order to increase ease of handling, it may be desirable to apply colorant to the substrate in stages. For example, colorant, and sealant if needed or desired, may be applied to the bottom surface of the substrate, and this may be allowed to dry before colorant, and sealant if needed or desired, is applied to the shoulder surface, top surface, or entire dome surface of the substrate. In certain embodiments, it may be desirable or convenient to apply colorant, and sealant if needed or desired, to the bottom surface of the substrate; then affix the substrate to an object, a backing, or a setting; then apply colorant, and sealant if needed or desired, to the shoulder surface, top surface, or entire dome surface of the substrate. Other sequences of applying colorant, and sealant if needed or desired, will be readily apparent to the skilled artisan who is given the teachings of the present invention and are encompassed within the scope of the present invention.

A decorative ornament of the present invention may be used, for example, to decorate or enhance any object to which it can be directly affixed by using glues, epoxies, cements, and other suitable adhesives. The bottom surface of the decorative ornament is preferably affixed to the object.

Suitable adhesives are preferably those that do not react with or damage the colorant or sealant in a manner that is visible to the naked eye when the element is attached to the object. Damage of or reaction with the colorant or sealant that is only evident if the element is removed from the object does not render an adhesive unsuitable. Suitable adhesives are preferably those that affix the decorative ornament to the object securely enough to withstand normal wear and tear in the object's intended use. A preferred adhesive is hot glue.

Non-limiting examples of objects to which decorative ornaments of the present invention may be directly affixed include: household items, such as lamps, lampshades, vases, tiles, furniture, glassware, ceramic items, toothbrush holders, soap dispensers and dishes, and tissue box covers; office and desktop items, such as pencil holders, organizers, business card holders, blotter covers, and letter openers; wearable items, such as hats, jewelry, cufflinks, tie tacks, zipper pulls, clothing; scarves, belts, shoes, barrettes and other hair accessories; and accessories such as handbags, wallets, makeup cases, money clips, and business card cases.

Decorative ornaments of the present invention may be affixed to a backing, such as a button or a piece of fabric, lace, leather, plastic, or metal using an adhesive such as those described above. The bottom surface of the decorative ornament is preferably affixed to the backing. The surface of the backing that is affixed to the decorative ornament may be the same size as, smaller than, or larger than the bottom surface of the decorative ornament to which it is affixed.

The backing may vary or further enhance the visual properties of the decorative ornament. For example, where the substrate, colorant, and sealant, if present, are sufficiently translucent, the color or texture of the backing may be seen through the substrate. As another example, where surface of the backing that is affixed to the decorative ornament is larger than the bottom surface of the decorative ornament to which it is affixed, the backing will be visible.

A backing with a decorative ornament affixed thereto may be affixed to an object to be decorated, such as the objects described above, using an adhesive such as those described above. Where the backing is fabric, leather, or another material amenable to sewing, the backing with decorative ornament affixed thereto may be affixed to an item to be decorated by sewing.

In most embodiments, decorative ornaments of the present invention are the same or similar shape to natural stone cabochons. Methods of setting cabochons are well known in the art and easily adapted to setting decorative ornaments of the present invention. Decorative ornaments of the present invention may be set in jewelry settings, such as bezel or prong settings. Decorative ornaments of the present invention may also be set in jewelry settings constructed or adapted to accept items to be glued or otherwise affixed thereon. Decorative ornaments of the present invention may be set in settings constructed or adapted to accept more than one item, such as a decorative ornament of the present invention, in a single setting. When a setting constructed or adapted to accept more than one item is used, decorative ornaments of the present invention may be set in combination with other items, such as crystals, stones, art glass, fused glass, and shells. A wide variety of settings is commercially available, and settings may also be custom made.

Exemplary settings include settings that incorporate a ring for wearing on a finger; settings that incorporate a bail or ring for wearing on a chain, necklace, bracelet, or zipper pull; settings that are integrated with a an earring; settings that are integrated with a tie tack; settings that are integrated with a cuff link; and settings that are integrated with a pin. Another exemplary setting is a bracelet or necklace having flat elements linked together, wherein items, such as decorative ornaments of the present invention, may be affixed to the flat elements using adhesives such as those described above.

A decorative ornament according to the present invention is preferably set so that bottom surface of the decorative ornament is facing down toward the bottom of the setting or is affixed to the setting.

Decorative ornaments according to the present invention that are set in settings may be affixed to objects such as those to which they may be directly affixed. Affixation may be accomplished using adhesives, such as those described above, jewelry elements or findings, wiring, sewing or stitching, or any other method capable of affixing the set decorative ornament to the object securely enough to withstand normal wear and tear in the object's intended use. Decorative ornaments according to the present invention that are set in settings can also be used individually, joined or affixed together, or joined or affixed to other jewelry elements or findings to make jewelry and accessories, such as rings, necklaces, pins, bracelets, handbag straps, cufflinks, tie tacks, hair accessories, zipper pulls, and belts. Methods for joining or affixing settings together or to other jewelry elements or findings are well known in the art of jewelry-making and include, for example, wiring, stringing, joining with adhesives, such as those described herein, and joining with jump or split rings.

The present invention also provides kits for making and using the inventive decorative ornaments. Kits for making decorative ornaments of the invention optionally include any one or more of substrates, colorants, and sealants. The kit may further include decorative items such as glitter. The kit may further include backings.

Kits for using decorative ornaments of the invention optionally include pre-made decorative ornaments of the invention, or any one or more of substrates, colorants, and sealants for making decorative ornaments of the invention. Kits for using decorative ornaments of the invention also optionally include any one or more of adhesive, objects(s) to be decorated, jewelry settings, and jewelry findings. The kit may further include backings.

The components of the kit are packaged together in a common container, typically including instructions for performing selected specific embodiments of the methods disclosed herein.

While relatively toxic materials may be used as colorants and sealants in accordance with the present invention, the use of such relatively toxic materials is not necessary, as non-toxic or relatively non-toxic materials may be used to produce inventive decorative ornaments having a remarkable and unexpected depth and jewel-like appearance. Likewise, no expensive equipment, and little or no training, is required to produce inventive decorative ornaments having a remarkable and unexpected depth and jewel-like appearance. Additionally, although those of skill in the fields of decorative arts and crafts and jewelry making, may make more complex decorative ornaments according to the present invention, little or no training is required to produce inventive decorative ornaments having a remarkable and unexpected depth and jewel-like appearance, and the methods of the present invention may be performed the relatively unskilled and untrained person, once that person is given the teachings herein.

### EQUIVALENTS

Many modifications and variations of this invention can be made without departing from its spirit and scope, as will be apparent to those skilled in the art who are given the teachings of the present invention. The specific embodiments described herein are offered by way of example only, and the invention is to be limited only by the terms of the appended claims along with the full scope of equivalents to which such claims are entitled.

What is claimed is:

1. A method for making a decorative ornament comprising the steps of:
providing a transparent, semi-transparent, or translucent solid substrate having at least one raised convex or domed surface and at least one relatively flat or concave surface; and
applying at least one colorant to at least one relatively flat or concave surface of the substrate, wherein at least one of the at least one colorant also acts as a sealant.

2. A method for making a decorative ornament comprising the steps of:
providing a transparent, semi-transparent, or translucent solid substrate having at least one raised convex or domed surface and at least one relatively flat or concave surface;
applying a first colorant to at least one relatively flat or concave surface of the substrate; and
applying at least one sealant to seal the colorant.

3. The method of claim 2, comprising the additional step of applying a second colorant to the same relatively flat or concave surface of the substrate to which the first colorant is applied.

4. The method of claim 3, wherein the first colorant is translucent and the second colorant is opaque.

5. The method of claim 3, wherein the second colorant is applied in a pattern resembling veining or inclusions in natural stone.

6. The method of claim 3, wherein the second colorant is applied in a geometric pattern.

7. The method of claim 3, wherein the second colorant is applied in the shape of a letter or letters.

8. A decorative ornament comprising:
a transparent, semi-transparent, or translucent solid substrate having at least one raised convex or domed surface and at least one relatively flat or concave surface; and
at least one colorant applied to at least one relatively flat or concave surface of the substrate, wherein at least one of the at least one colorant also acts as a sealant.

9. A decorative ornament comprising:
a transparent, semi-transparent, or translucent solid substrate having at least one raised convex or domed surface and at least one relatively flat or concave surface;
a first colorant applied to at least one relatively flat or concave surface of the substrate; and
a sealant sealing the colorant.

10. The decorative ornament of claim 9, comprising a second colorant applied to the same relatively flat or concave surface of the substrate to which the first colorant is applied.

11. The decorative ornament of claim 11, wherein the first colorant is translucent and the second colorant is opaque.

12. The decorative ornament of claim 11, wherein the second colorant is applied in a pattern resembling veining or inclusions in natural stone.

13. The decorative ornament of claim 11, wherein the second colorant is applied in a geometric pattern.

14. The decorative ornament of claim 11, wherein the second colorant is applied in the shape of a letter or letters.
